(19) United States
(12) Patent Application Publication
(10) Pub. No.: US 2022/0112107 A1
(43) Pub. Date: Apr. 14, 2022

(54) Integrated System For Water Treatment Energized By Sustainable Hydrogen

(71) Applicant: David Haberman, Delray Beach, FL (US)

(72) Inventor: David Haberman, Delray Beach, FL (US)

(21) Appl. No.: 17/499,307

(22) Filed: Oct. 12, 2021

Related U.S. Application Data
(60) Provisional application No. 63/090,571, filed on Oct. 12, 2020.
(60) Provisional application No. 63/106,556, filed on Oct. 28, 2020.

(51) Int. Cl. C02F 1/74; C02F 1/26; C02F 1/04; H02S 10/12; H02S 10/20; H02S 40/42

(52) U.S. Cl. CPC C02F 1/74; C02F 1/265; C02F 1/048; C02F 2103/34; H02S 10/20; H02S 40/425; H02S 10/12

(57) ABSTRACT

Provided is a method for providing an integrated system for water treatment energized by sustainable hydrogen, including the steps of: generating electrical power from at least two renewable power producing systems, wherein the renewable power producing systems comprise at least a solar photovoltaic cell and a wind turbine; converting the electrical power with a controller in electrical communication with the two renewable power producing systems and a power bus to power an electrolyzer.

### CROSS-REFERENCE TO RELATED APPLICATIONS

This patent claims the benefit of U.S. Provisional Patent Application 63/090571, filed 12 Oct. 2020, titled Integrated System For Water Treatment Energized By Sustainable Hydrogen, and U.S. Provisional Patent Application 63/106,556, filed 28 Oct. 2020, titled Island Based System To Recycle CO2 From Combustion Emissions. The entire content of these applications are hereby incorporated by reference for all purposes.

### BACKGROUND

### 1. Field

The present disclosure relates generally to hydrogen production and use, and more particularly to renewable energy use to produce usable hydrogen and oxygen.

### 2. Description of the Related Art

Certain types of renewable energy such as solar energy and wind energy are erratic, producing power inconsistently, at times not necessarily coupled with periods of use, and in amounts unrelated to demand. Hydrogen use is increasing in areas such as fuel cells, with car manufacturers producing hydrogen powered fleet, commercial and consumer vehicles, and fueling stations are at their infancy in the western part of the United States and certain other countries. Electrolysis is a technique for splitting water molecules into its component hydrogen and oxygen molecules. This technique requires energy input and produces the two gaseous outputs, if compressed, can have industrial and commercial uses. Certain hydrogen energy uses are available, including liquid hydrogen or hydrogen fuel cells. These techniques utilize the hydrogen product of electrolysis and the oxygen portion is released as a byproduct. Certain oxygenuses are available, including oxygen as a use in aeration in wastewater treatment plants.

Techniques are needed to allow for efficient and maximal gathering of energy produced from renewable sources that can be used on demand in environmentally sensitive and cost effective manners, and that can utilize all byproducts of electrolysis.

### 3. SUMMARY

The following is a non-exhaustive listing of some aspects of the present techniques. These and other aspects are described in the following disclosure.

Some aspects include a method for providing an integrated system for water treatment energized by sustainable hydrogen, including the steps of: generating electrical power from at least two renewable power producing systems, wherein the renewable power producing systems comprise at least a solar photovoltaic cell and a wind turbine; converting the electrical power with a controller in electrical communication with the two renewable power producing systems and a power bus to power an electrolyzer, wherein: the electrolyzer is in communication with a water supply source; and the electrolyzer is capable of separating H2O into H2 and O2; and transporting from the electrolyzer, the H2 to a hydrogen storage module and transporting the O2 to an oxygen storage module, wherein: the hydrogen storage module comprises: at least a fuel cell to provide on demand electricity; and a H2 dispenser module; and the oxygen storage module comprises: a supply system for water treatment facility for aeration of wastewater.

Some aspects include a tangible, non-transitory, machine-readable medium storing instructions that when executed by a system cause the processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block logical and physical architecture diagram showing an embodiment of an integrated system for water treatment energized by sustainable hydrogen in accordance with some of the present techniques;

FIG. 2 is a flowchart showing an example of a process of an integrated system for water treatment energized by sustainable hydrogen in accordance with some of the present techniques; and

FIG. 3 shows an example of a computing device by which the above-described techniques may be implemented.

While the present techniques are susceptible to various modifications and alternative forms, specific embodiments thereof are shownby way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventor had to both invent solutions and, in some cases just as importantly, recognize problems overlooked (or not yet foreseen) by others in the field of hydrogen fuel production. Indeed, the inventors wish to emphasize the difficulty of utilizing the types of energy inputs described herein to produce usable amounts of hydrogen and oxygen in a manner that is economically viable and environmentally sound. Further, because multiple problems are addressed, it should be understood that some embodiments are problem-specific, and not all embodiments address every problem with traditional systems described herein or provide every benefit described herein. That said, improvements that solve various permutations of these problems are described below.

Water treatment and quality assurance may be essential to protect the health of the public. Some embodiments of the techniques taught here prioritizes operational reliability, source water flexibility, utilization of renewable energy resources and the integration of hydrogen energy system attributes to provide synergies and efficiencies not offered by the status quo of water treatment. There may be multiple applications of oxygen in water treatment which are established as effective and reliable. Certain aspects of the techniques described here in focus on the energy and source water upstream of these applications.

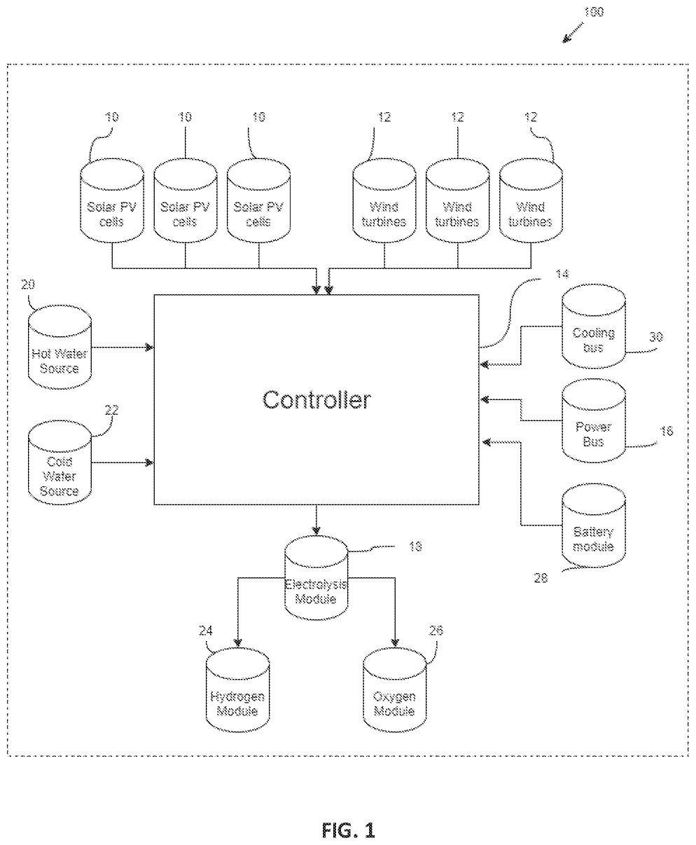

FIG. 1 is a schematic block diagram of an example of an integrated system 100 for water treatment energized by sustainable hydrogen, in which the present techniques may be implemented. A variety of different modules and computing architectures are contemplated. In some embodiments, some or all of the components of the system 100 may be hosted by different entities. In some embodiments, the system 100 and the components thereof may be implemented as a monolithic application, for instance, with different illustrated components implemented as different software modules or processes that communicate with one another, for instance via function calls, or in some cases, some or all of the components may be implemented as different processes executing concurrently on a single computing device. In some embodiments, some or all of the illustrated components may be implemented as distinct services executing on different network hosts that communicate with one another via messages exchanged via network stacks of the respective hosts, for instance, according to application program interfaces of each ofthe distinct services. In some embodiments, some or all of these services may be replicated, for instance, behind load balancers, to afford a relatively scalable architecture, in some cases, with elastic scaling that automatically spins up or down new instances based on load.

Some embodiments of the present disclosure include techniques for gathering electricity generated through renewable energy including photovoltaic cells 10, wind turbines 12, and other sources, and directing the energy to a controller 14. Electrical energy may be alternating current in certain sources (e.g., wind turbines) and may be direct current in certain other sources (e.g., photovoltaic cells) and may be transmitted to a power bus 16 in electrical communication with the controller. The electrical energy from the controller may be utilized in an electrolysis module 18, comprising components sufficient for electrolysis and a source of hot 20 or cold 22 water. The water sources may further include water purifications modules within each source. The products of the electrolysis may be separated into hydrogen molecules H₂ and oxygen molecules O₂. The electrolysis module may be in fluid communication with an oxygen module 26 and a hydrogen module 24, which may receive the products of the electrolysis respectively.

In some embodiments, through compressing techniques, hydrogen gas may be compressed into medium to and high pressure for commercial usage as commercial hydrogen gas, including multiple-hundred atmosphere pressure, and may be cooled to liquid hydrogen for storage or for use as a fuel source.

In some embodiments, the oxygen module 26 may gather oxygen and transmit the oxygen to a collocated industrial oxygen user, including a water treatment facility, for use in aeration or other such oxygenation techniques.

In some embodiments, solar energy may be used in black body and trough water collectors to heat water and transmit the water to hot water source 20 in fluid communication with the black body and trough collectors, which may serve as the supply to the electrolysis module 18.

In some embodiments, the solar heat may be used for the evaporative treatment of salt water, which produces supply for the electrolysis module. In some embodiments, heated water from the blackbody and trough collectors may be used within a high pressure spray cleaning system for photovoltaic (PV) cells to maintain high efficiency. The controller 14 may set specific recurring schedules for spray cleaning the photovoltaic cells based on fixed schedule (e.g., daily, weekly, etc.) or upon need (e.g., decreased PV efficiency)

In some embodiments, a cooling module may be provided within the cold water source 22 that may include thermoelectric cooling. In some embodiments, the thermoelectric coolers may be in electrical communication with the system's power bus 16 to provide thermoelectric cooling throughout the system 100. Cooled fluid, such as cooled water, may be circulated through the electrolysis module 18, the hydrogen module 24, the oxygen module 26, and other such needs for cooling.

In some embodiments, the thermoelectric coolers may be in fluid communication with a module for evaporating salt water into fresh water steam, used for the purpose of cooling that steam to liquid water, to serve as a supply to the electrolysis module 18.

In some embodiments, a cooling bus (e.g., heat pipes) 30 with a network of heat pipes may provide a backup thermal load if an embedded cooler trips a high temperature sensor.

In some embodiments, the system 100 may be a self-contained entity that uses the process of electrolysis and the storage capabilities of hydrogen and oxygen hydrogen as means to gather and store the energy produced from uneven and unpredictable power sources, such as renewable energy sources for use as needed, and utilizes both products of electrolysis through industrial use of oxygen such as aeration of wastewater to enable growth of aerobic bacteria on key pollutants such as biochemical oxygen demand (BOD) and ammonia during treatment. In some embodiments, advantages such as use of renewable energy, reduced carbon production, on demand power, wholly automated systems, collocated oxygen production for aeration, and production of environmentally beneficial power, may be reached.

Some embodiments may include a method for providing oxygen for aeration of wastewater and hydrogen for electrical energy, comprising the steps of generating electrical power from at least one renewable power producing system, said renewable power producing system comprising at least one of a solar photovoltaic cell, a wind turbine, and a battery module 28; converting the electrical power with a controller 14 in electrical communication with the at least one renewable power producing system to power an electrolysis module, said electrolysis module in communication with a water supply source, said electrolysis module 18 capable of separating H₂O into H₂ and O₂; transporting, from the electrolysis module, the H₂ to a hydrogen module 24 and transporting the O₂ to an oxygen module 26. In some embodiments, the hydrogen back of plant module comprises at least one of a fuel cell module to provide on demand electricity and a H₂ dispenser module. In some embodiments, the oxygen back of plant module comprises a supply system for water treatment facility for aeration of wastewater.

Some embodiments may include the method described above further comprising the step of using electricity from the at least one of the fuel cell module and H₂ dispenser module, wherein the generating step is substantially asynchronous from the on demand electricity.

Some embodiments may include the method described above further comprising the steps of generating electrical power from a battery module 28 ata time substantially concurrent with a lapse in power from one of the solar photovoltaic cell and the wind turbine; and switching modes of electricity generation to one of solar photovoltaic, wind turbine, and battery according to set criteria, at least one of said set criteria based on the ability of a mode to meet present electricity demands. In some embodiments, when the electricity demand is less than the electricity generation by the solar photovoltaic cells and the wind turbine, the excess amount may be stored in the battery module 28.

Some embodiments may include the method described above, wherein transporting the H₂ to a hydrogen back of plant module further comprises transporting the H₂ to a compressor of hydrogen to a pressure between 350-700 bar for dispensers, or between 5-15 bar range for fuel cell.

In some embodiments, the system 100 may be automated and non-man tended. In some embodiments, the system 100 may comprise a subset of modules such as a renewable power generation module, an electrical control and capacitance module, a thermal management module, a water management module, electrolysis and gas management module, output utilization (system loads) module, and a carbon accounting module.

In some embodiments, adequate situational awareness of the system performance and health may be achieved by permissive use of a dedicated controller polling a health subroutine at the box level. The system 100 may directly communicate to a cloud based information system that may be summarized on a performance dashboard available at the device level using established security protocols.

In some embodiments, the system may be implemented as designed to fail “softly” by progressing through a sequence of alerts, fault notifications tied to a compensatory set of mitigation instructions prior to proceeding to fault modes. The software which enables this logic may be resident at the box level controllers/cpu.

In some embodiments, the physical compartmentalization of functions may reflect the use of off-the-shelf equipment.

In some embodiments, the system may be packaged in environmentally shielded, weather proof shelters and containers.

In some embodiments, the calibrations may be tracked at the health monitoring system and expirations of calibrations are part of regular repair & maintenance (R&M) routines

In some embodiments, the telemetry by cellular transponder may be the baseline method to preserve box level settings, health and performance data and R&M logs. Active faults and failures are prioritized in transmission and periodic repetitions of notifications. Pending R&M activities and operational interruptions can be tied to a scheduling program to support administrative planning.

In some embodiments, the secure operation can be achieved by a three tiered approach: physical security at the modular housing level, password protected control pads at the equipment site and password protected operation at the system controller.

In some embodiments, the system 100 may be thermally optimized to prioritize enforcing the max temperature set point for the grid controller, the battery array/recharge circuit, the compressors in the gas balance of plant for O₂, H₂ and the electrolyzer. In some embodiments, a thermoelectric cooler may be embedded directly in contact with each of these critical elements where mechanical access is available. In some embodiments, the thermal load may be connected by heat pipe to the closest positioned thermoelectric cooler.

In some embodiments, gas quality may be assured by a series of purity chemical sensors located at multiple different places along piping system, and if there is a degradation trend identified then a series of alerts and notifications may be generated

In some embodiments, water quality may be assured by monitoring pH, optical quality, temperature, and selected chemistry

In some embodiments, power bus 16 may be isolated to ensure there is no cross failure between direct current (“dc”) and alternating current (“ac”). In some embodiments, if wind power is the system input then ac becomes the baseline reference, if solar pv is the only system input then dc is the baseline reference.

In some embodiments, controller logic may prioritize functional settings to protect the electrolyzer and the gas compressors from out of range conditions.

In some embodiments, system performance parameters may be compared in real time or substantially real time to a parametric model to identify deviations in system balance. Compensatory actions may be pre-programmed based on the extent of an detected deviations.

In some embodiments, water source may be either fresh or salt or both, and there may be separate tanks for each.

The system can be designed to use either or both salt and fresh water. In terms of salt water the filtered input line can be fed to a trough buffer tank with water pump where the water is circulated and exposed to the heat from a trough concentrator to its max thermal capacitance and directed to an closed evaporative reservoir which collects the salt and redirects the water vapor to a collection tank. That tank feeds the fresh water source inlet.

In some embodiments, the carbon accounting function may be a software program which reports analytical data to a cloud based information archive and a third party auditing function. The program receives information from the system controller, and the health monitoring system and the data stream from the system inputs and output. Its function in some embodiments may be to operate a proprietary calculus to derive the carbon footprint of the system operation and compare it to an inventory of benchmark metrics. Such techniques may include using a rate of carbon production from the renewable sources compared to non-renewables (e.g., hydrocarbons) on a per watt basis.

In some embodiments, the hydrogen fueled mobility may be supported by dispensing the compressed hydrogen gas at multiple pressure settings in accordance with SAE and other standards, or otherwise usable as a fuel source.

In some embodiments, the heat from the optical blackbody and parabolic trough collectors may be used for heating hot water directly for use in the cleaning of the surface of the photovoltaic (pv) panels. Some of this hot water may used in a heat exchanger for drying a desiccant that is used to dehumidify the oxygen from the electrolyzer. The higher temperature hot water produced by the trough system may be used to treat non-fresh water sources in the eventuality that fresh water is unavailable.

In some embodiments, the system capacity has no fundamental barrier to scaling upward, while functional focus and modularity at the configuration management level (box) is primarily reflective of market demand, there is limit on the size of the service load to be accommodated given adequate capital funding.

In some embodiments, the gas balance of plants (BoPs) for hydrogen and oxygen may comprise a sequentially connected network of pressurized tanks, compressors, treatment stages, intermediate instrumentation positions and sensor penetrations of the flow paths.

In some embodiments, the system controller 14 may use an operational flow model as the basis of continual comparison with operational data. The controller may apply analysis associated with using the comparison to identify trends, interdicting failure modes and adjusting functions to accommodate changing conditions outside of the control of the system.

In some embodiments, the health monitoring system may include a logic set that reflects a prioritization of protection of system devices and components. This reflects an applied weighting of the relative importance ofthe equipment and particularly the vulnerabilities to cascading failures or increased severity of likely outcomes of catastrophic failure modes. As an example oxygen and hydrogen gas may be contained in tanks with automatic relief devices that trigger a controlled and directional venting based on a temperature determination. One functional objective of the health monitoring system may be to preserve safety of the work area and subordinately preservation of the capital invested in the system.

In some embodiments, the health monitoring system may accept measurement data from embedded thin film RTD temperature (heat) sensors in a fuelcell module connected to to the hydrogen module 24. The sensors may be individually attached by mounting brackets to be in physical contact with the circumference of the bezels of the proton exchange membrane (pem) assemblies in the fuelcell stacks. The sensors may be energized by a separate power input to the fuelcell from the Power Bus 16. The RTD sensors may be arrayed symmetrically around the bezel and include platinum, nickel, and copper RTD types co-located (grouped) at physically accessible locations in approximately 90 degree placement positioning around the stack. The inputs of each group may be correlated by a weighted polling logic using IEEE/ASME published heat sensor data management techniques at the controller 14. In some embodiments, cumulative heat increase indications in proximity to the pem reaction zone, including the dc voltage collection plates, may be indicative of pending degradation of system performance and a likely eventual failure. In some embodiments, fuelcells may be equipped with proprietary asset protection techniques (e.g., thermal considerations) which have single points of failure in their intended protections of the fuelcell with little regard for the dependent loads.

In some embodiments, a combination of dissimilar solid state heat sensors arrayed in groupings that are not subject to geometric attitudinal is used to assure a “competitive sensing in the same proximity environment and specifically not connected to the pem control logic, and not connected to pem balance of plant and not connected to pem internal power distribution provides a high confidence predictive data stream predicated on the existence of thermal stress, either acute or cummulative. Using platinum, nickel and copper RTDs in a correlated fashion identifies metrological inadequacies of a specific RTD type and offers increased opportunities to identify anomalies from environmental influences that might asymmetrically effect a specific RTD type.

In some embodiments, this data stream to the health monitoring function is processed into operational mode data fields that are subject to system controller logic and processing. The use of dedicated heat sensors installed in the fuelcell module may enable timely notification to the health monitoring function, phased interdiction of unplanned service interrupts and protection of the high value loads.

In some embodiments, thermoelectric cooler, as a part of colling bus 30, may be a distributed array of solid state devices configured as targeted heat pumps which use direct current supplied by the power bus 16 to reject heat at a specific cooler's reactive surface to it's hotjunction element. The mechanization envisioned here may use an array of thermoelectric coolers each placed in immediate proximity to the surfaces experiencing or evidencing high temperatures as detected by RTDs. The thermoelectric coolers may be physically mounted on multiple system elements such as the batter module 28, power bus 16, cooling bus 30, hydrogen module 24, and oxygen module 26.

In some embodiments, the cooling bus 30 is envisioned as a connected set of thermal pathways (heat pipes) designed to accommodate the restrictive mechanistic access, support and placement challenges in distributed energy systems that may not be thermally optimized due to safety driven compartmentalization. The compartmentalization may be due to the handling of ignitable gases—both oxygen and hydrogen. The designation of different block of the system 100 in the prioritized thermoelectric cooling service may be based on their criticality in the system's overall function and the relatively high value of the associated equipment assets. The thermoelectric coolers are energizedby the system power bus 16. The power bus may be constantly informed of the system health status from the health monitoring function and any pending alerts which are assigned a weighted criticality level that is indicative of the probability that such an alert may degrade into an alarm. This information connectivity is used to enforce an asset protection protocol resident in the power bus and controlled by the controller 14 which prioritizes the thermoelectric coolers as power is reassigned in compliance with a criticality index anticipation of increased system degradations or failures. The weighted criteria of power assignment may use the IEEE published protocols for control of Thermoelectric Modules (TEMs).

In some embodiments, a distributed thermoelectric coolers may be used to protect the critical functional elements that may be subject to heat stresses or heat induced system degradations in a hydrogen energized water treatment system.

In some embodiments, monitoring water quality in terms of contaminants, detection of regulated toxics and real-time or anticipatory notifications of propagation or distribution of improperly treated water are the high value services whose electrical loads may be protected by targeted cooling of critical system functions. In some embodiments, a carbon accounting system may be embedded within the controller 14. This system may use a set of look-up tables that use the figures of merit established for electrolyzers and fuelcells as high confidence metrics for determining the carbon burden of renewably energized water electrolysis and associated downstream hydrogen gas conversion into load following direct current. The figures of merit may include the hydrogen and oxygen gas production efficiency of the electrolyzer within a certain temperature domain, the hydrogen gas conversion efficiency into DC electrical output from the fuel cell and the respective gas balance of plants (BoPs) energy use efficiency and thermal profile. These figures of merit may be determined in the system modeling and confirmed in the qualification phase prior to commissioning. Standard sensors utilizing IEEE published protocols may be employed for this data collection. The successive use of this information in a sequence of metric comparisons at the functional levels that enforces combined system reliability and data quality are of importance in order to verify a statistical confidence in the carbon emission avoidance from system operation. For example, if the electrolyzer outputs a hydrogen purity (SAE H2 standard) below fuel cell input requirements a derating variable may be assigned to the carbon performance level determination until the electrolysis output is verified as meeting gas quality standards. In another example, if the fuel cell DC output falls below 15 kWh per kg of hydrogen utilized, a similar derating may be assigned.

In some embodiments, the utilization of sustainable hydrogen energy to energize critical high value loads in water treatment may results in certifiable quantifications (accounting) of carbon release into the environment that has been avoided in comparison with non-sustainable energy methods. Specifically accounting for the resources used to split water (wind & solar renewable power), the water feedstock, and the recurring actions to maintain the system function and reliability (jointly tracked as system health) combine water quality treatment prioritizations with mitigating the carbon burden of that treatment are of importance.

In some embodiments, heated water from solar hot water generator (blackbody or trough concentrator) may be used to clean and maintain PV panels using a spray triggered by a pair of custom sensors: optical degradation sensor & accelerometer both mounted on the PV bezel, which indicates if the irradiance has decreased rapidly due to optical effect interference/accumulation of optical degrading coatings and a shock/vibration notification.

In some embodiments, the solar trough concentrator may use high heat to evaporate and desalinize the input salt water to the electrolyzer.

In some embodiments, the production of hydrogen using asynchronous wind power emulates an electrical capacitance in the form of hydrogen gas which may used on-demand to generate high reliability direct current from a fuel cell. It may be the specific time domain synergy.

In some embodiments, the power bus (ac/dc) that collects multi-time domain uses of power and reports them to the health monitoring and cloud telemetry. In some embodiments, the power bus has the ability to use the battery module to compensate for faults on one bus to obtain necessary power from the other source. In some embodiments, the controller may track performance and mode switching between electricity generating sources and the battery module.

In some embodiments, thermoelectric coolers may embedded inside or in immediate proximity to prioritized heat loads. These coolers may be engaged based on a closed circuit temperature sensor at each load. These coolers may be backed up by a secondary connection of heat pipes to each load. The coolers may be driven by fuelcell dc power which is non-harmonic and highly reliable electricity.

In some embodiments, the heat pipes may connect the prioritized thermal loads to a centralized backup thermal management system which controls a cooling bus 30, a cold water source 22 and the operation of a hot water source 20. The thermal management system may use a 3 tiered set of referenced temperatures each individually maintained with active calibration of each reference temperature using active cooling, cold water inputs and hot water generation.

In some embodiments, the H₂ BoP may be configured to operate the compression of hydrogen to serve the dispenser outputs requirements (350/700 bar) or the feed to the fuel cell which is in the 5-15 bar range. The compression energy use may be balanced to not stress the compressors past the high end of the optimum performance of pressure output as a function of power consumption.

In some embodiments, the oxygen balance of plant (BoP) may condition the gas water content and use an embedded gas temperature sensor to activate a thermal dryer. The gas dryer may be driven by the heat circuit of the solar energy system. The dry oxygen maybe a more efficient feedstock for ozone production by coronal discharge.

In some embodiments, the carbon accounting may track the system performance to assure accurate avoided carbon analysis and fast reporting to the 3rd party audit and credit generation authority. The automated reporting of an integrated sustainable energy system to a voluntary carbon market avoids manipulation of the data and supports data security. The system may utilize a block chain methodology of logging performance.

In some embodiments, the system may provide an economic value creation by creating a smart capacitance of power potential from asynchronous renewable sources (wind and solar and geothermal). Part of this value creation may be the time domain of energy demand which is normally a function of utility con sumer but since the renewable power is directed to splitting water the gases become the manifestation of power potential. It is the recharacterization of renewable energy electrical production to non-demand timing valuation functions that may be considered innovative. It may be also innovative to view O₂ capacitance as energy capacitance since it is normally a vented gas in electrolysis operations.

In some embodiments, the health monitoring and telemetry function are embedded in the controller and they can recover quickly from device faults and failures because the operational mode disruptions are anticipated by on-going comparison of the system performance against a comparative model which looks for degradation trends. The reset and recovery of the gas balance of plants may be faster than the status quo because the compression cycles are pre-sequenced to avoid pressure imbalances in the gas networks from abrupt shutdowns and restarts.

In some embodiments, the system may be scaled to fit growing oxygen applications demands as a function of renewable energy and water availability which avoids grid dependency for backup power contingencies to assure output capacity obligations—status quo. There may be no grid dependency necessary to scale up this system only a renewables installation footprint requirement.

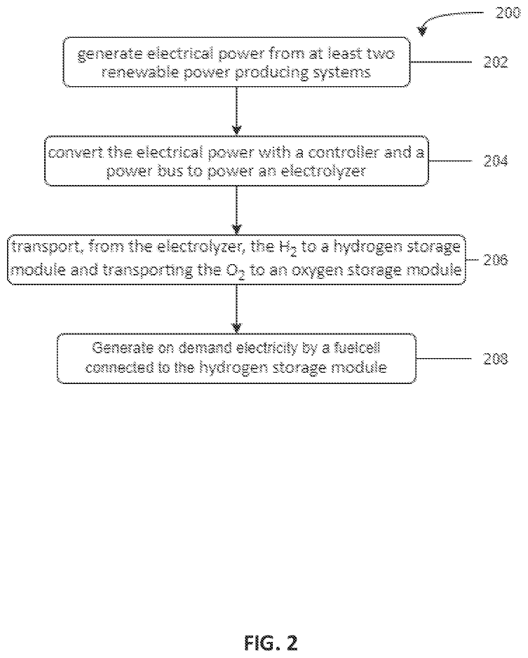

In some embodiments, the system 100 may be configured to execute the process 200 described below with reference to FIG. 2. In some embodiments, different sub sets ofthis process 200 may be executed by the illustrated components of the system 100, so those features are described herein concurrently. It should be emphasized, though, that embodiments of the process 200 are not limited to implementations with the architecture of FIG. 1, and that the architecture of FIG. 1 may execute processes different from that described with reference to FIG. 2, none of which is to suggest that any other description herein is limiting.

In some embodiments, electrical power may be generated from renewable power producing systems such as solar photovoltaic cells and wind turbines, as shown by block 202 in FIG. 2. The electrical power may be then used by a controller 14 in electrical communication with the two renewable power producing systems to power an electrolyzer 18, as shown by block 204 in FIG. 2. Thereafter, the electrolyzer 18 receive the water from a water source and separate water into H₂ and O₂. The separated H₂ and O₂ may be then transported to storage tanks, as shown by block 206 in FIG. 2. The stored hydrogen may be used by a fuelcell to create on demand electricity, as shown by block 208 in FIG. 2.

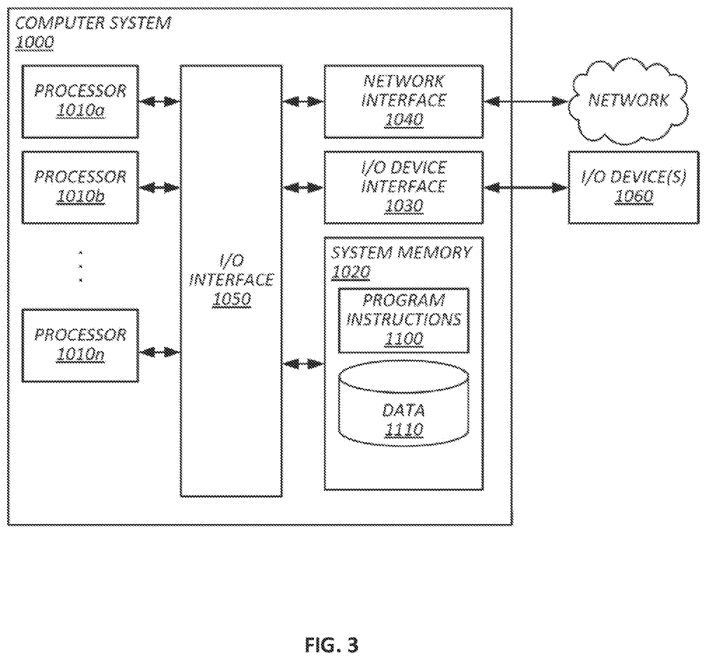

FIG. 3 is a diagram that illustrates an exemplary computing system 1000 by which embodiments of the present technique may be implemented. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g, system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g, from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further includereceiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have groupedthese techniques into a single document b ecause their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood ofthe consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwiseindicated, statements that “each” instance of some collection have some property should not be read to exclude cases where some otherwise identical or similar members of a larger collection do not have the property, i.e., each does not necessarily mean each and every. Limitations as to sequence of recited steps should notbe read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at leastZ of A, B, and C,” and the like (e.g., “at leastZ of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating” “determining” or the like refer to actions or processes of a specific apparatus, such as a special purpose computer or a similar special purpose electronic processing/computing device. Features described with reference to geometric constructs, like “parallel,” “perpindicular/orthogonal,” “square”, “cylindrical,” and the like, should be construed as encompassing items that substantially embody the properties of the geometric construct, e.g., reference to “parallel” surfaces encompasses sub stantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A method for providing an integrated system for water treatment energized by sustainable hydrogen, comprising the steps of: generating electrical power from at least two renewable power producing systems, wherein the renewable power producing systems comprise at least a solar photovoltaic cell and a wind turbine; converting the electrical power with a controller in electrical communication with the two renewable power producing systems and a power bus to power an electrolyzer, wherein: the electrolyzer is in communication with a water supply source; and the electrolyzer is capable of separating H₂O into H₂ and O₂; and transporting, from the electrolyzer, the H₂ to a hydrogen storage module and transporting the O₂ to an oxygen storage module, wherein: the hydrogen storage module comprises: at least a fuel cell to provide on demand electricity; and a H₂ dispenser module; and the oxygen storage module comprises: a supply system for water treatment facility for aeration of wastewater.
2. The method of claim 1 further comprising the steps of: generating electricity from the fuel cell and H₂ dispenser module, wherein the generating step is substantially asynchronous from the on demand electricity.
3. The method of claim 1 further comprising the steps of: imparting the electrical power from the two renewable power producing systems to a battery system.
4. The method of claim 1 further comprising the steps of: imparting electrical power from a battery system at a time substantially concurrent with a lapse in power from one of the solar photovoltaic cell or the wind turbine; and switching modes of electricity generation to one of solar photovoltaic, wind turbine, or imparting from the battery system according to a set criteria, at least one of the set criteria based on the ability of a mode to meet present electricity demands.
5. The method of claim 1, wherein the hydrogen storage module comprises a hydrogen back of plant module and the transportation of the H₂ to a hydrogen back of plant module further comprises: transporting the H₂ to a compressor of hydrogen to a pressure between 350-700 bar for the H₂ dispenser module; and transporting the H₂ to a compressor of hydrogen to a pressure between 5-15 bar range for the fuel cell.
6. The method of claim 1, wherein the solar photovoltaic cell comprises a spray triggered mechanism to wash the surface of the solar photovoltaic cell.
7. The method of claim 1 further comprising: steps for sustainable energy production in a water treatment facility.
8. The method of claim 1, wherein the heat generated in the solar photovoltaic cell is used to evaporate and desalinize the water supply source.
9. The method of claim 1 further comprising the steps of: cooling the solar photovoltaic cell via a thermoelectric cooler powered by the fuel cell.
10. The method of claim 1 further comprising the steps of: embedding a thermoelectric cooler directly in contact with the solar photovoltaic cell, the electrolyzer, the fuel cell, and the H₂ dispenser module; and maintaining the temperature of the solar photovoltaic cell, the electrolyzer, the fuel cell, and the H₂ dispenser module at the values set by the controller using the thermoelectric cooler.
11. A system for providing an integrated system for water treatment energized by sustainable hydrogen comprising: a first source of renewable energy imparting energy to an electrical substation, wherein the energy is alternating current; a second source of renewable energy imparting energy to the electrical substation, wherein the energy is direct current; an electrolyzer coupled to the electrical substation and capable of separating H₂O into H₂ and O₂; a water supply source in connection with the electrolyzer; a storage medium coupled to the electrical substation; a controller configured to direct the alternating and the direct currents from the electrical substation to the electrolyzer and the storage medium; and a plurality of storage tanks coupled to the electrolyzer, wherein the plurality of storage tanks comprises: a hydrogen tank; and an oxygen tank.
12. The system of claim 11 wherein the first source of renewable energy is wind turbine.
13. The system of claim 11 wherein the second source of renewable energy is photovoltaic cells.
14. The system of claim 11 further comprising an expander configured to capture work from expansion of the plurality of storage tanks, wherein the expander is coupled to the electrolyzer.
15. The system of claim 11, wherein: the hydrogen tank is connected to a fuel cell, to provide on demand electricity, and a H₂ dispenser module.
16. The system of claim 11, wherein: the electrical power from the two renewable power producing systems is imparted to a battery system.
17. The system of claim 11, wherein: the electrical power from a battery system is imparted at a time substantially concurrent with a lapse in power from one of the solar photovoltaic cell or the wind turbine.
18. The system of claim 11, wherein: the solar photovoltaic cell comprises a spray triggered mechanism to wash the surface of the solar photovoltaic cell.
19. The system of claim 11, wherein the heat generated in the solar photovoltaic cell is used to evaporate and desalinize the water supply source.
20. The system of claim 11, wherein the solar photovoltaic cell is configured to be cooled down via a thermoelectric cooler.

What is claimed is:

1. A method for providing an integrated system for water treatment energized by sustainable hydrogen, comprising the steps of:
generating electrical power from at least two renewable power producing systems, wherein the renewable power producing systems comprise at least a solar photovoltaic cell and a wind turbine;
converting the electrical power with a controller in electrical communication with the two renewable power producing systems and a power bus to power an electrolyzer, wherein:
the electrolyzer is in communication with a water supply source; and
the electrolyzer is capable of separating H₂O into H₂ and O₂; and
transporting, from the electrolyzer, the H₂ to a hydrogen storage module and transporting the O₂ to an oxygen storage module, wherein:
the hydrogen storage module comprises:
at least a fuel cell to provide on demand electricity; and
a H₂ dispenser module; and
the oxygen storage module comprises:
a supply system for water treatment facility for aeration of wastewater.

2. The method of claim 1 further comprising the steps of:
generating electricity from the fuel cell and H₂ dispenser module, wherein the generating step is substantially asynchronous from the on demand electricity.

3. The method of claim 1 further comprising the steps of:
imparting the electrical power from the two renewable power producing systems to a battery system.

4. The method of claim 1 further comprising the steps of:
imparting electrical power from a battery system at a time substantially concurrent with a lapse in power from one of the solar photovoltaic cell or the wind turbine; and
switching modes of electricity generation to one of solar photovoltaic, wind turbine, or imparting from the battery system according to a set criteria, at least one of the set criteria based on the ability of a mode to meet present electricity demands.

5. The method of claim 1, wherein the hydrogen storage module comprises a hydrogen back of plant module and the transportation of the H₂ to a hydrogen back of plant module further comprises:
transporting the H₂ to a compressor of hydrogen to a pressure between 350-700 bar for the H₂ dispenser module; and
transporting the H₂ to a compressor of hydrogen to a pressure between 5-15 bar range for the fuel cell.

6. The method of claim 1, wherein the solar photovoltaic cell comprises a spray triggered mechanism to wash the surface of the solar photovoltaic cell.

7. The method of claim 1 further comprising:
steps for sustainable energy production in a water treatment facility.

8. The method of claim 1, wherein the heat generated in the solar photovoltaic cell is used to evaporate and desalinize the water supply source.

9. The method of claim 1 further comprising the steps of:
cooling the solar photovoltaic cell via a thermoelectric cooler powered by the fuel cell.

10. The method of claim 1 further comprising the steps of:
embedding a thermoelectric cooler directly in contact with the solar photovoltaic cell, the electrolyzer, the fuel cell, and the H₂ dispenser module; and
maintaining the temperature of the solar photovoltaic cell, the electrolyzer, the fuel cell, and the H₂ dispenser module at the values set by the controller using the thermoelectric cooler.

11. A system for providing an integrated system for water treatment energized by sustainable hydrogen comprising:
a first source of renewable energy imparting energy to an electrical sub station, wherein the energy is alternating current;
a second source of renewable energy imparting energy to the electrical substation, wherein the energy is direct current;
an electrolyzer coupled to the electrical substation and capable of separating H₂O into H₂ and O₂;
a water supply source in connection with the electrolyzer;
a storage medium coupled to the electrical substation;
a controller configured to direct the alternating and the direct currents from the electrical substation to the electrolyzer and the storage medium; and
a plurality of storage tanks coupled to the electrolyzer, wherein the plurality of storage tanks comprises:
a hydrogen tank; and
an oxygen tank.

12. The system of claim 11 wherein the first source of renewable energy is wind turbine.

13. The system of claim 11 wherein the second source of renewable energy is photovoltaic cells.

14. The system of claim 13, wherein:
the photovoltaic cell comprises a spray triggered mechanism to wash the surface of the solar photovoltaic cell.

15. The system of claim 13, wherein the heat generated in the photovoltaic cell is used to evaporate and desalinize the water supply source.

16. The system of claim 13, wherein the photovoltaic cell is configured to be cooled down via a thermoelectric cooler.

17. The system of claim 11 further comprising an expander configured to capture work from expansion of the plurality of storage tanks, wherein the expander is coupled to the electrolyzer.

18. The system of claim 11, wherein:
the hydrogen tank is connected to a fuel cell, to provide on demand electricity, and a H₂ dispenser module.

19. The system of claim 11, wherein:
the electrical power from the first and the second sources of renewable power producing systems is imparted to a battery system.

20. The system of claim 11, wherein:
the electrical power from a battery system is imparted at a time substantially concurrent with a lapse in power from one of the first and the second sources of renewable power producing systems.
